(19) United States
(12) Patent Application Publication
(10) Pub. No.: US 2005/0069212 A1
(43) Pub. Date: Mar. 31, 2005

(54) Video encoding and decoding method and device

(75) Inventors: Vincent Bottreau, Paris (FR); Marion Benetiere, Rueil Malmaison (FR)

Correspondence Address: US Philips Corporation;Intellectual Property Department, PO Box 3001, Briarcliff Manor, NY, 10510, US

(73) Assignee: Koninklijke Philips Electronics N.V, Eindhoven (NL)

(21) Appl. No.: 10/498,755

(22) PCT Filed: Dec. 9, 2002
(86) PCT No.: PCT/IB02/05306

(30) Foreign Application Priority Data
Dec. 20, 2001 (EP) 01403319.5

(51) Int. Cl. G06K 9/36

(52) U.S. Cl. 382/240

(57) ABSTRACT

The invention relates to an encoding method for the compression of a video sequence divided into groups of frames (GOFs), each of which is decomposed by means of a three-dimensional (3D) wavelet transform comprising successively, at each decomposition level, a motion compensation step, a temporal filtering step, and a spatial decomposition step. The motion compensation is based on a motion estimation leading to motion vectors which are encoded and put in the coded bitstream together with, and just before, the coded texture information of the concerned spatial decomposition level. The encoding operation of the motion vectors is carried out at the lowest spatial resolution, and only refinement bits of said motion vectors at each of the other spatial resolutions are put in the coded bitstream refinement bitplane by refinement bitplane. Specific markers are introduced in the coded bitstream for indicating the end of the bitplanes, the temporal decomposition levels and the spatial decomposition levels respectively. According to the present invention, for each temporal decomposition level, additional specific markers are then introduced in the coded bitstream, for indicating in each spatial decomposition level the end of the motion vector information related to said spatial decomposition level. This solution allows, in case of very low decoding bitrate, to skip the residual motion information and to decode only the texture information, or, in another implementation, to skip said residual motion information and also the remaining spatial levels of the concerned temporal level.

The invention relates to an encoding method for the compression of a video sequence divided into groups of frames (GOFs) themselves subdivided into couples of frames, each of said GOFs being decomposed by means of a three-dimensional (3D) wavelet transform comprising successively, at each decomposition level, a motion compensation step between the two frames of each couple of frames, a temporal filtering step, and a spatial decomposition step of each temporal subband thus obtained, said motion compensation being based for each temporal decomposition level on a motion estimation performed at the highest spatial resolution level, the motion vectors thus obtained being divided by powers of two in order to obtain the motion vectors also for the lower spatial resolutions, the estimated motion vectors allowing to reconstruct any spatial resolution level being encoded and put in the coded bitstream together with, and just before, the coded texture information formed by the wavelet coefficients at this given spatial level, said encoding operation being carried out on said estimated motion vectors at the lowest spatial resolution, only refinement bits of said motion vectors at each spatial resolution being then put in the coded bitstream refinement bitplane by refinement bitplane, from one resolution level to the other, and specific markers being introduced in said coded bitstream for indicating the end of the bitplanes, the temporal decomposition levels and the spatial decomposition levels respectively.

The invention also relates to a corresponding encoding device, to a transmittable video signal consisting of a coded bitstream generated by such an encoding device, to corresponding decoding devices, and to computer executable process steps for use in such decoding devices.

Video streaming over heterogeneous networks requires a high scalability capability, i.e. that parts of a bitstream can be decoded without a complete decoding of the coded sequence and can be combined to reconstruct the initial video information at lower spatial or temporal resolutions (spatial scalability, temporal scalability) or with lower quality (SNR or bitrate scalability). A convenient way to achieve these three types of scalability (spatial, temporal, SNR) is a three-dimensional subband decomposition of the input video sequence, after a motion compensation of said sequence (for the design of an efficient scalable video coding scheme, motion estimation and motion compensation are indeed key components, but with some contradictory requirements, which are mainly to provide a good temporal prediction while keeping the motion information overhead low in order not to reduce drastically the bit budget available for texture encoding/decoding).

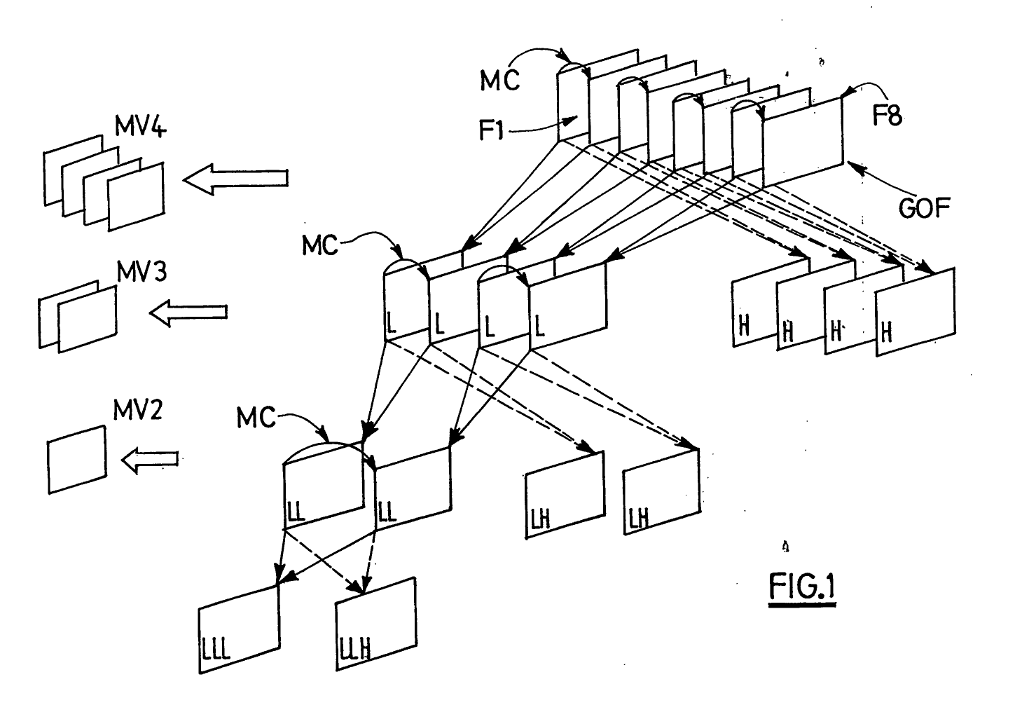

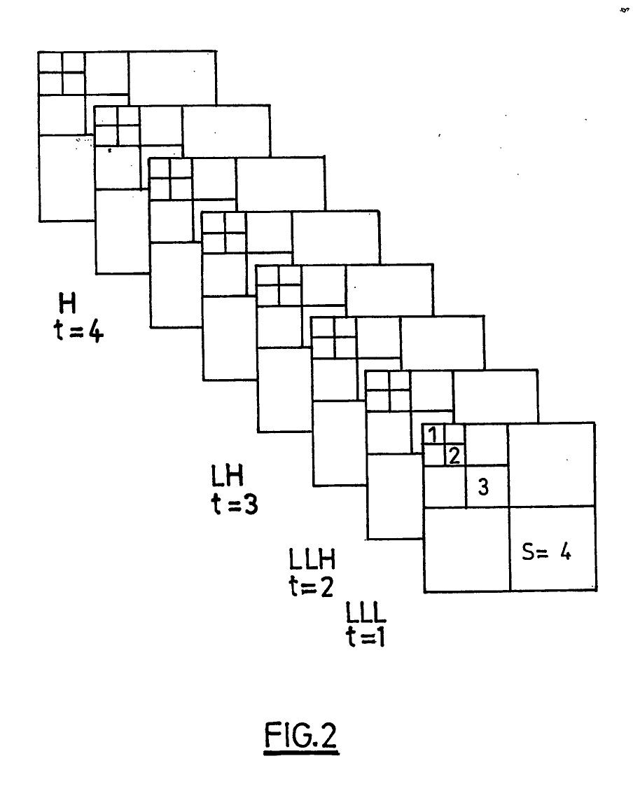

A fully scalable video coding method has been already described in the document WO 02/01881 (PHFR000070). The main characteristics of this method are first recalled, with reference to FIG. 1 that illustrates a temporal subband decomposition of a video sequence. The illustrated 3D wavelet decomposition with motion compensation is applied to a group of frames (GOF), in which the frames are referenced F1 to F8. Each GOF is first motion-compensated (MC), in order to process sequences with large motion, and then temporally filtered (TF) using Haar wavelets (the dotted arrows correspond to a high-pass temporal filtering, while the other ones correspond to a low-pass temporal filtering). After the motion compensation operation and the temporal filtering operation, each temporal subband is spatially decomposed into a spatio-temporal subband, which finally leads to a 3D wavelet representation of the original GOF, as illustrated in FIG. 2. In the example of FIGS. 1 and 2, three stages of decomposition have been shown (L and H=first stage; LL and LH=second stage; LLL and LLH=third stage), a group of motion vector fields being generated at each temporal decomposition level: MV4 at the first level, MV3 at the second one, MV2 at the third one (in fact, one motion vector field is generated between every two frames in the considered GOF at each temporal decomposition level, and the number of motion vector fields is therefore, with the example of three decomposition levels, equal to half the number of frames in the temporal subband, i.e. four at the first level of motion vector fields, two at the second one, and one at the third one).

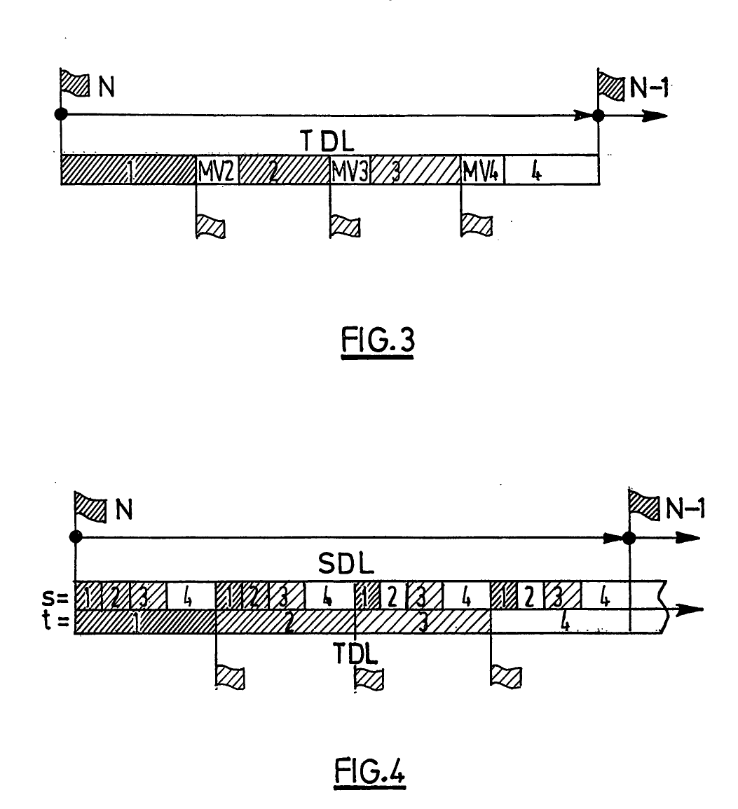

At the decoder side, in the case of temporal scalability, in order to allow a progressive decoding, the bitstream has then been organized as described for example in FIG. 3: the three temporal decomposition levels of FIG. 1, now called TDL, yield four temporal resolution levels (1 to 4), which represent the possible frame rates that can be obtained from the initial frame rate. The coefficients corresponding to the lowest resolution temporal level are first encoded (1), without sending motion vectors at this level, and, for all the other reconstruction frame rates (2, 3, 4), the motion vector fields MV2 to MV4 and the frames of the corresponding high frequency temporal subbands 2 to 4 are encoded. This description of the bitstream organization only takes into account the temporal levels, and the spatial scalability inside each temporal level has also to be considered, which leads to the complete scalability solution reminded in FIG. 4: inside each temporal scale, all the spatial resolutions are successively scanned (SDL=spatial decomposition levels), and therefore all the spatial frequencies are available (frame rates t=1 to 4; display sizes s=1 to 4). Markers are used to separate the bitplanes (flags A between two bitplanes) and the temporal levels (flags B between two successive temporal decomposition levels.

In the case of spatial scalability, in order to be able to reconstruct a reduced spatial resolution video, it then appeared as not desirable to transmit at the beginning of the bitstream the motion vector fields of full resolution, and the solution proposed to this end in the cited document was to adapt the motion described by the motion vectors to the size of the current spatial level: a low resolution motion vector field corresponding to the lowest spatial resolution was first transmitted, and the resolution of the motion vectors was progressively increased according to the increase in the spatial resolution, only the difference between a motion vector field resolution and another one being encoded and transmitted (in the technical solution thus described, the motion vectors are assumed to be obtained by means of a block-based motion estimation method like full search block matching or any other derived solution and the size of the blocks in the motion estimation must then chosen carefully: indeed, if the original size of the block is 8×8 in the full resolution, it becomes 4×4 in the half resolution, then 2×2 in the quarter, and so on, and consequently, a problem may appear if the original size of the blocks is too small, which leads to always check that the original size is compatible with the number of decomposition/reconstruction levels).

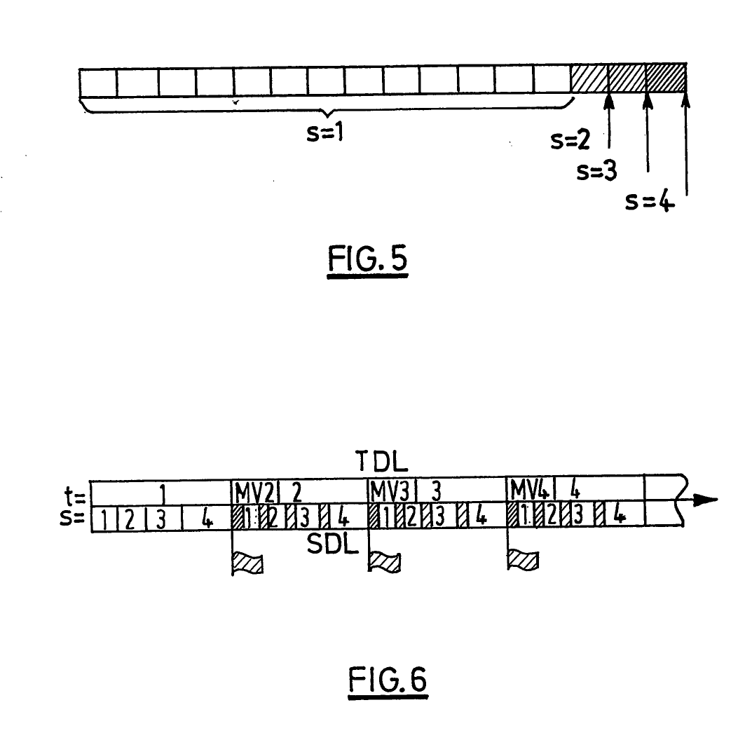

With for instance s spatial decomposition levels, if one wants the motion vectors corresponding to all possible resolutions, either the initial motion vectors are divided by 2^{s} or a shift of s positions is performed, the result representing the motion vectors corresponding to the blocks from lowest resolution the size of which is divided by 2^{s}. A division by 2^{s-}1 of the original motion vector would provide the next spatial resolution, but this value is already available from the previous operation: it corresponds to a shift of s−1 positions. The difference, with respect to the first operation, is the bit in the binary representation of the motion vector with a weight of 2^{S-1}. It is then sufficient to add this bit (called refinement bit) to the previously transmitted vector to reconstruct the motion vector at a higher resolution, which is illustrated in FIG. 5 for s=4. This progressive transmission of the motion vectors allows, as illustrated in FIG. 6, to include in the bitstream the refinement bits of the motion vector fields from one spatial resolution to another, just before the bits corresponding to the texture at the same spatial level. As above, markers are used to separate the spatial levels (flags C between two successive levels).

Thanks to this scalable motion vector encoding method (such as described in the cited document and hereinabove recalled), the hierarchy of the temporal and spatial levels has been transposed to the motion vector coding, allowing to decode the motion information progressively: for a given spatial resolution, the decoder has no longer to decode parts of the bitstream that are not useful at that level. However, although said scalable vector encoding method ensures a fully progressive bitstream, the overhead of the motion information may become too high in case of decoding at very low bitrate, leading to the following drawback: the incapacity to decode texture bits for lack of available budget, and therefore a very poor reconstruction quality.

It is therefore an object of the invention to propose an encoding method avoiding this drawback, and therefore more adapted to the situation where high bitrate scalability must be obtained, i.e. when decoding bitrate is much lower than encoding bitrate.

To this end, the invention relates to an encoding method such as defined in the introductory part of the description and which is moreover characterized in that, for each temporal decomposition level, additional specific markers are introduced into said coded bitstream, for indicating in each spatial decomposition level the end of the motion vector information related to said spatial decomposition level.

Another object of the invention is to propose an encoding device for carrying out said encoding method.

To this end, the invention relates to a device for encoding a video sequence divided into groups of frames (GOFs) themselves subdivided into couples of frames, each of said GOFs being decomposed by means of a three-dimensional (3D) wavelet transform comprising successively, at each decomposition level, a motion compensation step between the two frames of each couple of frames, a temporal filtering step, and a spatial decomposition step of each temporal subband thus obtained, said motion compensation being based for each temporal decomposition level on a motion estimation performed at the highest spatial resolution level, the motion vectors thus obtained being divided by powers of two in order to obtain the motion vectors also for the lower spatial resolutions, the estimated motion vectors allowing to reconstruct any spatial resolution level being encoded and put in the coded bitstream together with, and just before, the coded texture information formed by the wavelet coefficients at this given spatial level, said encoding operation being carried out on said estimated motion vectors at the lowest spatial resolution, only refinement bits of said motion vectors at each spatial resolution being then put in the coded bitstream refinement bitplane by refinement bitplane, from one resolution level to the other, and specific markers being introduced in said coded bitstream for indicating the end of the bitplanes, the temporal decomposition levels and the spatial decomposition levels respectively, said encoding device comprising motion estimation means, for determining from said video sequence the motion vectors associated to all couples of frames, 3D wavelet transform means, for carrying out within each GOF, on the basis of said video sequence and said motion vectors, successively a motion compensation step, a temporal filtering step, and a spatial decomposition step, and encoding means, for coding both coefficients issued from said transform means and motion vectors delivered by said motion estimating means and yielding said coded bitstream, said encoding device being further characterized in that it also comprises means for introducing into said coded bitstream additional specific markers for indicating in each spatial decomposition level the end of the motion vector information related to said spatial decomposition level.

The invention also relates to a transmittable video signal consisting of a coded bistream generated by such an encoding device, said coded bitstream being characterized in that it comprises additional specific markers for indicating in each spatial decomposition level the end of the motion vector information related to said spatial decomposition level.

Another object of the invention is to propose a device for decoding a bitstream generated by carrying out the encoding method such as proposed.

To this end, the invention relates to a device for decoding a coded bitstream generated by carrying out the above-described encoding method, said decoding device comprising decoding means, for decoding in said coded bitstream both coefficients and motion vectors, inverse 3D wavelet transform means, for reconstructing an output video sequence on the basis of the decoded coefficients and motion vectors, and resource controlling means, for defining before each motion vector decoding process the amount of bit budget already spent and for deciding, on the basis of said amount, to stop, or not, the decoding operation concerning the motion information, by means of a skipping operation of the residual part of said motion information, or to a device for decoding a coded bitstream generated by carrying out said encoding method, said decoding device comprising decoding means, for decoding in said coded bitstream both coefficients and motion vectors, inverse 3D wavelet transform means, for reconstructing an output video sequence on the basis of the decoded coefficients and motion vectors, and resource controlling means, for defining before each motion vector decoding process the amount of bit budget already spent and for deciding, on the basis of said amount, to stop, or not, the decoding operation concerning the motion information and the residual part of the concerned spatial decomposition level, by means of a skipping operation of the residual part of said motion information and the following residual part of the concerned spatial decomposition level.

The invention also relates to computer executable process steps for use in such decoding devices.

The present invention will now be described, by way of example, with reference to the accompanying drawings in which:

FIG. 1 illustrates a temporal subband decomposition with motion compensation;

FIG. 2 shows the spatio-temporal subbands resulting from a three-dimensional wavelet decomposition;

FIG. 3 illustrates a motion vector insertion in the bitstream for temporal scalability;

FIG. 4 shows the structure of the bitstream obtained with a temporally driven scanning of the spatio-temporal tree;

FIG. 5 is a binary representation of a motion vector and its progressive transmission from the lowest resolution to the highest one;

FIG. 6 shows the bitstream organization for motion vector coding in the fully scalable approach described in the document WO 02/01881 previously cited;

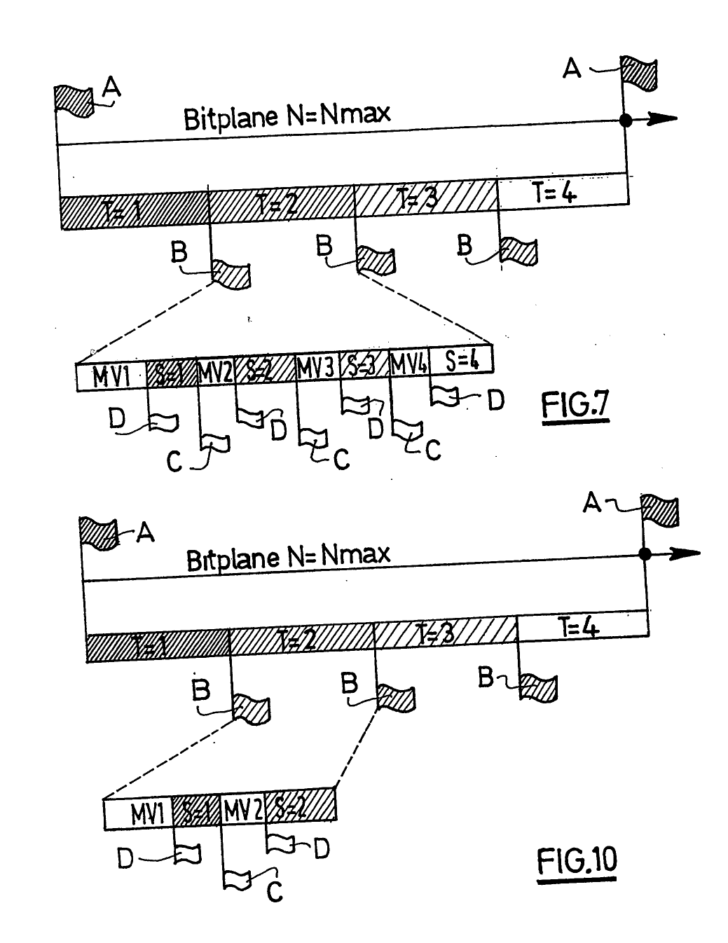

FIG. 7 shows a coded bitstream obtained when performing the encoding method according to the invention and allows to understand how said coded bitstream is then decoded according to the invention;

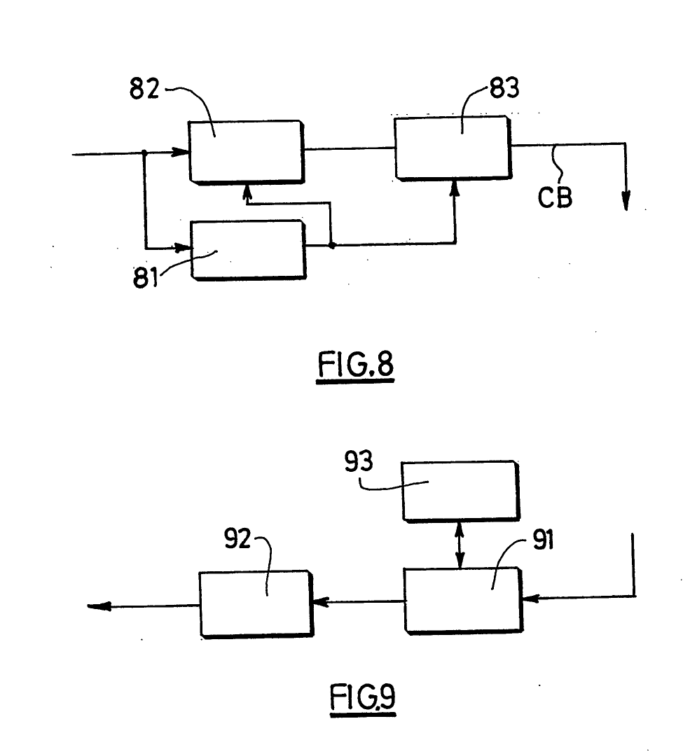

FIGS. 8 and 9 show an encoding and a decoding device for carrying out respectively the encoding and decoding method according to the invention;

FIG. 10 shows another representation of the coded bitstream, and illustrates another implementation of the decoding method according to the invention.

The solution illustrated in FIG. 6 assumed that the first bitplane (each bitplane, comprised between two flags of type A and corresponding to a given quality, contains information about all the temporal levels, each temporal level corresponding to a given framerate) should be fully reconstructed at the decoder side, that is to say that the decoding bitrate (unknown a priori at the encoder side) should be sufficient to completely reconstruct at least this bitplane, which corresponds to the lowest reconstruction parameters in terms of quality, frame rate and spatial resolution that the decoder can reach (each temporal level contains information about all the spatial levels, and each spatial level corresponds to a given spatial resolution). However, in practical applications where scalability is fully exploited, the decoding bitrate may be too low, at a given instant (for instance due to a network congestion), to decode this particular bitplane according to the desired decoding parameters (for instance, the user may need a reconstruction at full framerate and full spatial resolution). When this situation occurs, the quality of the reconstruction becomes unacceptable since the first bitplane only contains a coarse average of the video, whereas several additional bitplanes have to be decoded so as to obtain also the video details and to get a visually acceptable reconstruction quality.

Under these particular circumstances, it is proposed, according to the invention, to focus on texture bit decoding to the detriment of motion vector decoding and to introduce, during the implementation of the decoding process, a decision that allows or not to continue decoding the motion vectors. Given a certain decoding bitrate, the amount of bit budget already spent is checked before each motion vector decoding process (approximation MV1 or further MVi). If this amount exceeds a certain percentage (M %) of the total bit budget, the motion overhead is assumed to be too high to allow decoding of further detail bitplanes, and it is decided not to decode the remaining parts of motion information so as to save bits for the following texture coefficients. In order to be able to implement this technical solution, the decoder must be able to skip the parts of the bitstream corresponding to the motion vectors so as to jump directly to the next texture part. For instance in FIG. 7, the above-mentioned critical percentage may be reached while decoding motion vectors in MV2, and the algorithm then needs to resynchronize the decoding process at the beginning of s=2. According to the invention, additional specific markers—the flags referenced D—are added at the end of the motion vector information, as described in FIG. 7, so as to enable an easy and direct access to texture bits.

The encoding method thus described may be implemented in an encoding device such as illustrated in FIG. 8 and which comprises the following main modules. First, a motion estimation circuit 81, receiving the input video sequence, carries out (by means of the block matching algorithm, preferably) the estimation of the motion vectors. Then, a 3D wavelet transform circuit 82 receives the input video sequence and the estimated motion vectors and carries out the motion compensation step, the temporal filtering step and the spatial decomposition step. The coefficients yielded by the transform circuit 82 and the motion vectors available at the output of the circuit 81 are finally received by encoding means, comprising for instance in series an encoding device 83 and an arithmetic encoding device 84, and provided for coding both coefficients issued from the wavelet transform and vectors issued from the motion estimation, the coded bitstream CB available at the output of said encoding means being transmitted (in view of its reception by a decoder) or stored (in view of a later reception by a decoder or by a server).

At the decoding side (or in a server), the corresponding decoding method may be implemented in a decoding device such as illustrated in FIG. 9 and which comprises the following main modules. The received coded bitstream is first processed by a decoding device 91, comprising for instance in series an arithmetic decoding stage and a decoding stage, provided for decoding the coded bitstream including the coded coefficients and the coded motion vectors. The decoded coefficients and motion vectors are then received by an inverse 3D wavelet transform circuit 92 which is provided for reconstructing an output video sequence corresponding to the original one. The decoding device also comprises a resource controller 93, which is in charge of the checking operation, i.e. which has to verify before each motion vector decoding process the amount of bit budget already spent and to decide, on the basis of said amount, to stop, or not, the decoding operation concerning the motion information and to decode only the residual texture information of the concerned spatial decomposition level, thus still allowing an acceptable reconstruction quality.

The method as proposed may however introduce a drift between the coding and decoding operations when the motion vector decoding operation is stopped at a certain spatio-temporal level: if further spatio-temporal levels are still decoded, no motion compensation will indeed be performed for these remaining resolutions, including the one under reconstruction. In order to limit this drawback, and taking into account the fact that since a great part of the bit budget available for decoding has been already reached for the first bitplane, it is proposed, according to the invention, to dynamically reduce the set of decoding parameters, for instance, by reducing the frame rate or the spatial resolution according to given requirements of the application, so as to obtain a visually acceptable reconstruction quality. The spatio-temporal resolution for which the motion vector decoding operation is stopped has to be reconstructed at the maximum quality allowed by the available bit budget, and higher resolutions may be given up. Thus, accent is here on the in-depth exploration of the bitplanes for the current spatio-temporal resolution instead of trying to reconstruct all of them, which will be anyway of poor quality according to the above-mentioned decoding conditions. This is illustrated in FIG. 10, where, according to the invention, it has been chosen to stop the motion vector decoding operation from the second spatial resolution. The remaining two spatial levels have been then also dropped for each temporal resolution, which corresponds to decoding at quarter spatial resolution but at full frame rate.

The foregoing description of the preferred embodiments of the invention has been presented for purposes of illustration and description. It is not intended to be exhaustive or to limit the invention to the precise form disclosed, and obviously many modifications and variations, apparent to a person skilled in the art and intended to be included within the scope of this invention, are possible in light of the above teachings.

It may for example be understood that the devices described herein can be implemented in hardware, software, or a combination of hardware and software, without excluding that a single item of hardware or software can carry out several functions or that an assembly of items of hardware and software or both carry out a single function. These devices may be implemented by any type of computer system—or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

1. An encoding method for the compression of a video sequence divided into groups of frames (GOFs) themselves subdivided into couples of frames, each of said. GOFs being decomposed by means of a three-dimensional (3D) wavelet transform comprising successively, at each decomposition level, a motion compensation step between the two frames of each couple of frames, a temporal filtering step, and a spatial decomposition step of each temporal subband thus obtained, said motion compensation being based for each temporal decomposition level on a motion estimation performed at the highest spatial resolution level, the motion vectors thus obtained being divided by powers of two in order to obtain the motion vectors also for the lower spatial resolutions, the estimated motion vectors allowing to reconstruct any spatial resolution level being encoded and put in the coded bitstream together with, and just before, the coded texture information formed by the wavelet coefficients at this given spatial level, said encoding operation being carried out on said estimated motion vectors at the lowest spatial resolution, only refinement bits of said motion vectors at each spatial resolution being then put in the coded bitstream refinement bitplane by refinement bitplane, from one resolution level to the other, and specific markers being introduced in said coded bitstream for indicating the end of the bitplanes, the temporal decomposition levels and the spatial decomposition levels respectively, said method being characterized in that, for each temporal decomposition level, additional specific markers are introduced in said coded bitstream, for indicating in each spatial decomposition level the end of the motion vector information related to said spatial decomposition level.

2. A device for encoding a video sequence divided into groups of frames (GOFs) themselves subdivided into couples of frames, each of said GOFs being decomposed by means of a three-dimensional (3D) wavelet transform comprising successively, at each decomposition level, a motion compensation step between the two frames of each couple of frames, a temporal filtering step, and a spatial decomposition step of each temporal subband thus obtained, said motion compensation being based for each temporal decomposition level on a motion estimation performed at the highest spatial resolution level, the motion vectors thus obtained being divided by powers of two in order to obtain the motion vectors also for the lower spatial resolutions, the estimated motion vectors allowing to reconstruct any spatial resolution level being encoded and put in the coded bitstream together with, and just before, the coded texture information formed by the wavelet coefficients at this given spatial level, said encoding operation being carried out on said estimated motion vectors at the lowest spatial resolution, only refinement bits of said motion vectors at each spatial resolution being then put in the coded bitstream refinement bitplane by refinement bitplane, from one resolution level to the other, and specific markers being introduced in said coded bitstream for indicating the end of the bitplanes, the temporal decomposition levels and the spatial decomposition levels respectively, said encoding device comprising motion estimation means, for determining from said video sequence the motion vectors associated to all couples of frames, 3D wavelet transform means, for carrying out within each GOF, on the basis of said video sequence and said motion vectors, successively a motion compensation step, a temporal filtering step, and a spatial decomposition step, and encoding means, for coding both coefficients issued from said transform means and motion vectors delivered by said motion estimating means and yielding said coded bitstream, said encoding device being further characterized in that it also comprises means for introducing into said coded bitstream additional specific markers for indicating in each spatial decomposition level the end of the motion vector information related to said spatial decomposition level.

3. A transmittable video signal consisting of a coded bistream generated by an encoding device according to claim 2, said coded bitstream being characterized in that it comprises additional specific markers for indicating in each spatial decomposition level the end of the motion vector information related to said spatial decomposition level.

4. A device for decoding a coded bitstream generated by carrying out an encoding method according to claim 1, said decoding device comprising decoding means, for decoding in said coded bitstream both coefficients and motion vectors, inverse 3D wavelet transform means, for reconstructing an output video sequence on the basis of the decoded coefficients and motion vectors, and resource controlling means, for defining before each motion vector decoding process the amount of bit budget already spent and for deciding, on the basis of said amount, to stop, or not, the decoding operation concerning the motion information, by means of a skipping operation of the residual part of said motion information.

5. Computer executable process steps for use in a device for decoding a coded bitstream generated by carrying out an encoding method according to claim 1, said process steps comprising a decoding step, for decoding in said coded bitstream both coefficients and motion vectors, an inverse 3D wavelet transform steps, for reconstructing an output video sequence on the basis of the decoded coefficients and motion vectors, and a resource controlling means, for defining before each motion vector decoding process the amount of bit budget already spent and for deciding, on the basis of said amount, to stop, or not, the decoding operation concerning the motion information, by means of a skipping operation of the residual part of said motion information.

6. A device for decoding a coded bitstream generated by carrying out an encoding method according to claim 1, said decoding device comprising decoding means, for decoding in said coded bitstream both coefficients and motion vectors, inverse 3D wavelet transform means, for reconstructing an output video sequence on the basis of the decoded coefficients and motion vectors, and resource controlling means, for defining before each motion vector decoding process the amount of bit budget already spent and for deciding, on the basis of said amount, to stop, or not, the decoding operation concerning the motion information and the residual part of the concerned spatial decomposition level, by means of a skipping operation of the residual part of said motion information and the following residual part of the concerned spatial decomposition level.

7. Computer executable process steps for use in a device for decoding a coded bitstream generated by carrying out an encoding method according to claim 1, said process steps comprising a decoding step, for decoding in said coded bitstream both coefficients and motion vectors, an inverse 3D wavelet transform step, for reconstructing an output video sequence on the basis of the decoded coefficients and motion vectors, and a resource controlling step, for defining before each motion vector decoding process the amount of bit budget already spent and for deciding, on the basis of said amount, to stop, or not, the decoding operation concerning the motion information and the residual part of the concerned spatial decomposition level, by means of a skipping operation of the residual part of said motion information and the following residual part of the concerned spatial decomposition level.
